(19) United States
(12) Patent Application Publication
(10) Pub. No.: US 2012/0104274 A1
(43) Pub. Date: May 3, 2012

(54) ION BEAM GENERATING APPARATUS, SUBSTRATE PROCESSING APPARATUS AND METHOD OF MANUFACTURING ELECTRONIC DEVICE

(75) Inventors: Hirohisa Hirayanagi, Kawasaki-shi (JP); Ayumu Miyoshi, Kawasaki-shi (JP); Einstein Noel Abarra, Kawasaki-shi (JP)

(73) Assignee: CANON ANELVA CORPORATION, Kawasaki-shi (JP)

(21) Appl. No.: 13/382,002

(22) PCT Filed: Jul. 13, 2010
(86) PCT No.: PCT/JP2010/004522

§ 371 Date: Jan. 3, 2012

(30) Foreign Application Priority Data
Jul. 16, 2009 (JP) 2009-167441
Jul. 16, 2009 (JP) 2009-167451

(51) Int. Cl. G21K 5/00; B01J 19/08; H01J 27/02

(52) U.S. Cl. 250/424; 250/423 R

(57) ABSTRACT

There is provided an ion beam generating apparatus capable of reducing power consumption and obtain highly-accurate uniformity in a substrate process without providing a mechanism to rotate a substrate. Each of ion beam generating apparatuses 1a and 1b includes a discharging tank for generating plasma, an extraction electrode including an inclined portion arranged so as to be inclined with respect to an irradiated surface for extracting an ion generated in the discharging tank, a rotating driving unit 30 provided out of the discharging tank for rotating the extraction electrode, and a rotation supporting member 31 for coupling the rotating driving unit 30 and the extraction electrode 7, wherein an insulator block 34 arranged around the rotation supporting member 31 is included in the discharging tank.

### TECHNICAL FIELD

The present invention relates to an ion beam generating apparatus, a substrate processing apparatus in which the ion beam apparatuses are provided so as to be opposed to each other, and a method of manufacturing an electronic device using the same.

### BACKGROUND ART

In association with minimization of a semiconductor substrate and a magnetic disc substrate, a technique to uniformly perform microfabrication and planarization of a surface with higher accuracy is required. The patent reference 1 discloses a semiconductor processing apparatus in which an accelerating grid is provided so as to be inclined with respect to a surface of the semiconductor in order to realize the highly-accurate surface process. Also, the patent reference 2 discloses an ion gun, comprising a plasma generating source and an extraction electrode including a plurality of electrode plates with a plurality of through holes such that an ion generated by the plasma generating source passes therethrough, wherein the extraction electrode includes a first electrode including a portion on one side of a predetermined reference surface crossing across the electrode plates in the plurality of electrode plates and is inclined with respect to the reference surface such that the portion faces a predetermined irradiated area on a side spaced apart from the plasma generating source than the extraction electrode on the reference surface and a second electrode including a portion on the other side of the reference surface on the plurality of electrode plates and is inclined with respect to the reference surface such that the portion faces the irradiated area for planarizing both surfaces of the substrate.

### PRIOR ART REFERENCE

### Patent Reference

Patent Reference 1: Japanese Patent Application Laid-Open No. 60-127732
Patent Reference 2: Japanese Patent Application Laid-Open No. 2008-117753

### SUMMARY OF THE INVENTION

### Problem to be Solved by the Invention

However, in the semiconductor processing apparatus according to the patent document 1, there is a problem that highly-accurate uniformity in a substrate process cannot be obtained because distances between the positions on the substrate and the extraction electrode are different from one another. On the other hand, although it is possible to rotate the substrate as the ion gun according to the patent document 2, it is not possible to provide a mechanism for rotating the substrate because of a limitation in the apparatus in which miniaturization is required, especially, the apparatus of which deposition is performed on the both surfaces of the substrate.

Then, an object of the present invention is to provide the ion beam generating apparatus capable of obtaining the highly-accurate uniformity without providing the mechanism to rotate the substrate.

### Means for Solving the Problem

An ion beam generating apparatus of the present invention comprises a discharging tank for generating plasma, an extraction electrode including an inclined portion arranged so as to be inclined with respect to an irradiated surface for extracting an ion generated in the discharging tank, and a rotating driving unit for rotating the extraction electrode.

Also, a substrate processing apparatus of the present invention comprises a substrate holder for holding a substrate, wherein the ion beam generating apparatus of the present invention is provided so as to face each of both surfaces of the substrate.

Further, a method of manufacturing an electronic device of the present invention is the method using an ion beam generating apparatus comprising a discharging tank for generating plasma, an extraction electrode including an inclined portion arranged so as to be inclined with respect to an irradiated surface for extracting an ion generated in the discharging tank, and a rotating driving unit for rotating the extraction electrode. The method comprises a substrate arranging step for arranging a substrate such that a surface of the substrate is inclined with respect to the inclined portion of the extraction electrode, an emitting step for extracting the ion from the inclined portion of the extraction electrode to emit the ion to the substrate, and a rotating step for rotating the extraction electrode.

### Effects of the Invention

According to the present invention, the ion beam generating apparatus capable of reducing the power consumption and obtaining the highly-accurate uniformity in the substrate process without providing the mechanism to rotate the substrate may be provided. Therefore, according to the present invention, the surface process of the substrate using the ion beam may be excellently performed when manufacturing the electronic device.

### BRIEF DESCRIPTION OF THE DRAWINGS

FIG. 1 is a schematic diagram illustrating an entire configuration of one embodiment of a substrate processing apparatus according to the present invention;

FIG. 2 is a view illustrating a configuration example of a carrier for holding a substrate in the apparatus in FIG. 1;

FIG. 3 is a cross-sectional view illustrating a detailed configuration of one embodiment of the ion beam generating apparatus according to the present invention;

FIG. 4 is a top view and a side view illustrating a detailed configuration of an example of an extraction electrode of the ion beam generating apparatus according to the present invention;

FIG. 5 is a top view and a side view illustrating a detailed configuration of another example of the extraction electrode of the ion beam generating apparatus according to the present invention;

FIG. 6 is a cross-sectional view illustrating a detailed configuration of still another example of the extraction electrode of the ion beam generating apparatus according to the present invention;

FIG. 7 is a top view and a side view of the extraction electrode in FIG. 6;

FIG. 8 is a top view and a side view illustrating a detailed configuration of still another example of the extraction electrode of the ion beam generating apparatus according to the present invention;

FIG. 9 is a cross-sectional view for illustrating a detailed configuration of still another example of the extraction electrode of the ion beam generating apparatus according to the present invention;

FIG. 10 is a view illustrating positional relationship between an outer periphery of an opening of a sealing container and the extraction electrode in the ion beam generating apparatus according to the present invention;

FIG. 11 is a cross-sectional view illustrating a detailed configuration of the ion beam generating apparatus according to one embodiment of the substrate processing apparatus according to the present invention;

FIG. 12 is a cross-sectional view taken along line X-X according to FIG. 11;

FIG. 13 is a cross-sectional view illustrating a detailed configuration of the ion beam generating apparatus according to another embodiment of the substrate processing apparatus according to the present invention;

FIG. 14 is a sectional side view illustrating a detailed configuration of a rotating driving unit and a voltage applying mechanism of the ion beam generating apparatus according to the present invention;

FIG. 15 is a view illustrating a reason for rotating the extraction electrode in the ion beam generating apparatus according to the present invention;

FIG. 16 is a schematic diagram illustrating an effect of minute etching with use of the ion beam generating apparatus according to the present invention;

FIG. 17 is a schematic diagram illustrating an effect of planarization etching using the ion beam generating apparatus according to the present invention;

FIG. 18 is a block diagram illustrating a discrete track media processing/depositing apparatus using the substrate processing apparatus according to the present invention;

FIG. 19 is a cross-sectional schematic diagram illustrating a discrete track media processing/depositing process flow using the apparatus in FIG. 18; and

FIG. 20 is a cross-sectional schematic diagram illustrating the discrete track media processing/depositing process flow using the apparatus in FIG. 18.

### MODE FOR CARRYING OUT THE INVENTION

Although an embodiment of the present invention is hereinafter described with reference to the drawings, the present invention is not limited to this embodiment.

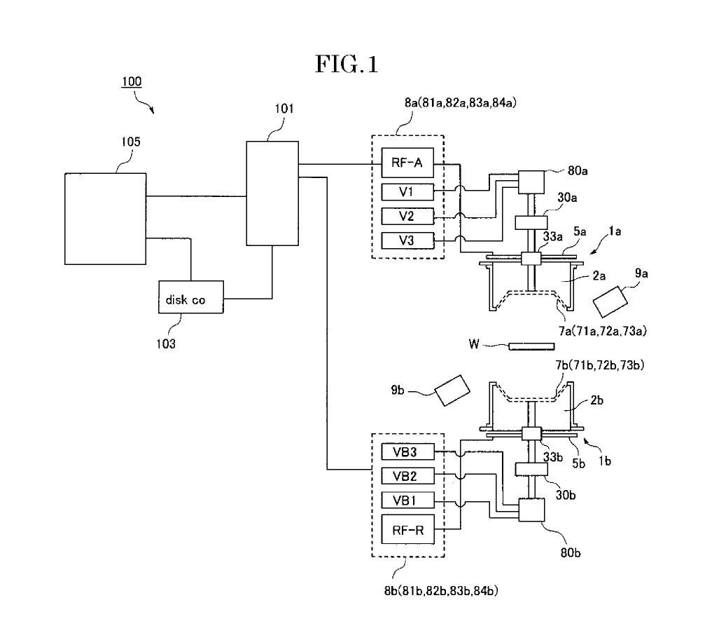

One embodiment of a substrate processing apparatus of the present invention is described with reference to FIG. 1. FIG. 1 is a block diagram illustrating a configuration of the substrate processing apparatus of this embodiment seen from above.

As illustrated in FIG. 1, a substrate processing apparatus 100 is basically provided with a substrate (wafer) W, first and second ion beam generating apparatuses 1a and 1b arranged so as to be opposed to each other across the substrate W, a controller 101, a counter 103, and a computer interface 105.

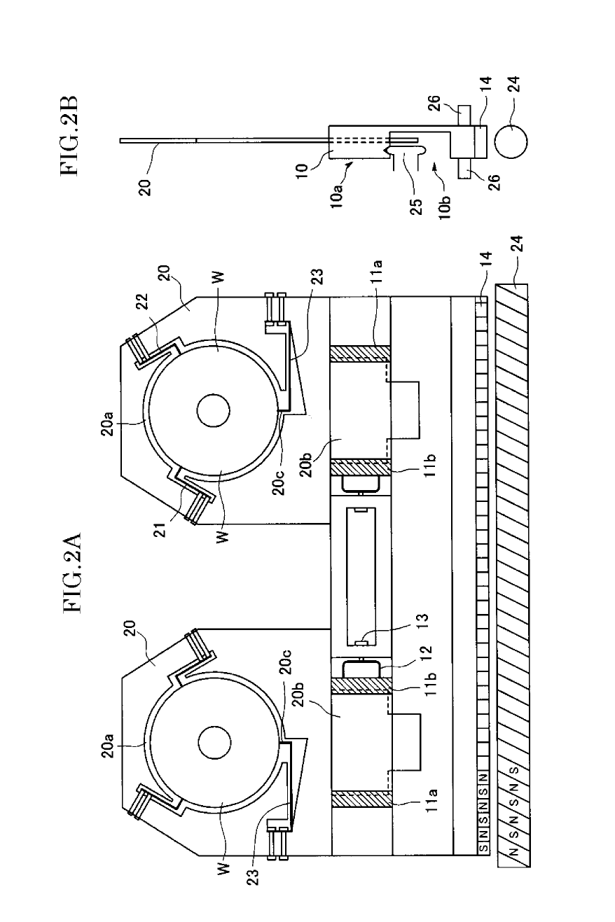

The substrate W in this embodiment is a substrate for a magnetic recording medium such as a hard disk, and an opening is formed in the center of a substantially disk-shaped substrate in general. The substrate W is held in an upright position in a vertical direction by a substrate carrier as illustrated in FIG. 2, for example.

One configuration example of a substrate carrier device (carrier) is herein described with reference to FIG. 2. FIGS. 2A and 2B are schematic front view and side view illustrating a structure of the carrier. As illustrated in FIG. 2, the carrier is composed of two substrate holders 20 and a slider member 10, which holds the substrate holders 20 in the vertical direction (longitudinal direction) and moves on a carrying path. As the slider member 10 and the substrate holder 20, light-weight Al (A5052) and the like is used in general.

The substrate holder 20 has a circular opening 20a in the center thereof into which the substrate W is inserted, and has a shape of which width decreases in two steps on a lower side thereof. L-shaped spring members 21, 22, and 23 of Inconel (R) are attached to three portions around the opening 20a and the spring member (movable spring member) 23 is configured to be pushed downward. A V-shaped groove for gripping an outer peripheral end face of the substrate is formed on a tip end of each of the spring members 21, 22, and 23 to be protruded in the opening 20a. Herein, the spring members 21, 22, and 23 are attached in a rotationally symmetrical manner. Also, supporting claws of the two spring members 21 and 22 are arranged on positions symmetrical about a vertical line passing through the center of the opening of the substrate holder and the supporting claw of the movable spring member 23 is arranged on the vertical line. By arranging them in this manner, even if the center of the opening of the substrate holder 20 and the center of the substrate W to be mounted are slightly misaligned for some reasons when mounting the substrate W on the carrier, force is applied in a rotating direction of the substrate W, so that the substrate W may be held by the three supporting claws more evenly and misalignment increased by thermal expansion may be solved. A side end face of an intermediate portion 20b of the substrate holder 20 is held by insulating members 11a and 11b such as alumina attached in the slider member 10. Also, a tip end 20c of the spring member 23 becomes a contacting site with a contact point for applying substrate bias.

The slider member 10 has a C-shaped cross-sectional shape with a concave portion 10b formed on the center thereof, and a slit-shaped groove for holding the intermediate portion 20b of the substrate holder 20 is formed on an upper thick portion 10a so as to penetrate the concave portion 10b as illustrated in FIG. 2B. A pair of insulating members 11a and 11b are arranged on both ends in the slit-shaped groove, the insulating member 11a on an end side of the slider member 10 is fixed in the groove and the insulating member 11b on a central side of the slider member 10 is arranged so as to be movable rightward and leftward. Further, a plate spring 12 is attached so as to energize the movable insulating member 11b toward the end side of the slider member 10. In this manner, when the substrate holder 20 is inserted into the groove of the slider member and a screw 13 is fastened, the substrate holder is pressed against an outer side of the carrier to be strongly fixed.

Also, a great number of magnets 14 are attached to a bottom portion of the slider member 10 such that magnetic directions thereof are alternately opposite as described above, and the slider member 10 moves by a mutual effect with a rotating magnet 24 arranged along the carrying path. Meanwhile, a guide roller 25 for preventing disengagement of the slider from the carrying path and a roller 26 for preventing turnover are attached to the carrying path at predetermined intervals.

With reference to FIG. 1 again, the first and second ion beam generating apparatuses 1a and 1b are arranged so as to be opposed to each other across the substrate W so as to face both surfaces of the substrate W. That is to say, each of the first and second ion beam generating apparatuses 1a and 1b is arranged so as to irradiate an area therebetween with an ion beam, and the substrate carrier, which has the opening and, holds the substrate W, is arranged in the area.

The first ion beam generating apparatus 1a is provided with a radio-frequency (RF) electrode 5a, a discharging tank 2a for generating plasma, and an extraction electrode 7a as an extracting mechanism of an ion in the plasma (electrodes 71a, 72a, and 73a from a side of the substrate). The electrodes 71a, 72a, and 73a are connected to voltage sources 81a, 82a, and 83a so as to be independently controllable. A neutralizer 9a is provided in the vicinity of the extraction electrode 7a. The neutralizer 9a is configured to be able to emit an electron so as to neutralize the ion beam emitted by the ion beam generating apparatus 1a.

Gas introducing means not illustrated supplies processing gas such as argon (Ar) into the discharging tank 2a. The gas introducing means supplies Ar into the discharging tank 2a and a source of RF source 84a applies RF power to the electrode 5a, thereby generating the plasma. The ion in the plasma is extracted by the extraction electrode 7a to apply an etching process to the substrate W.

Since the second ion beam generating apparatus 1b is configured similarly with the above-described ion beam generating apparatus 1a, so that the description thereof will not be repeated here.

The controller 101 is connected to voltage sources 8a and 8b of the ion beam generating apparatuses 1a and 1b, respectively, to control the voltage sources 8a and 8b.

The computer interface 105 is connected to the controller 101 and the counter 103 and is configured such that a user of the apparatus may input a cleaning condition (processing time and the like).

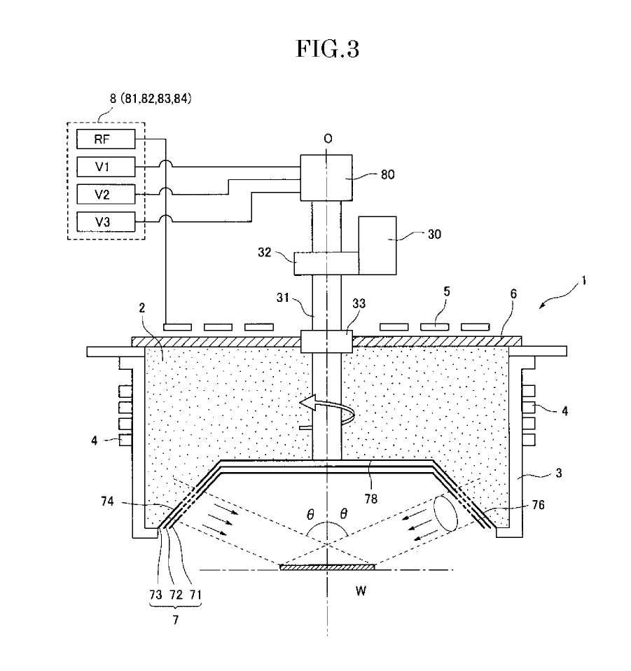

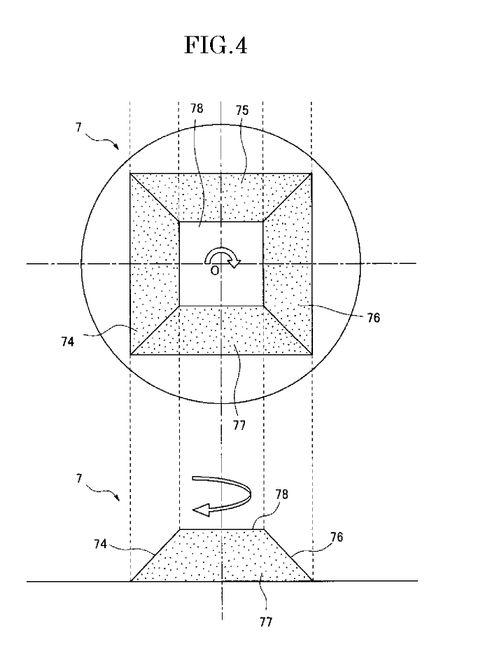

Next, the ion beam generating apparatuses 1 (1a and 1b) are described in detail with reference to FIGS. 3 and 4.

FIG. 3 is a schematic cross-sectional view illustrating a detailed structure of one embodiment of the ion beam generating apparatus of the present invention. FIG. 4 is a top view and a side view illustrating a shape of an example of the extraction electrode. Meanwhile, the structures of the first and second ion beam generating apparatuses 1a and 1b are common, so that a branch reference letter such as a and b is appropriately omitted in the description.

As illustrated in FIG. 3, the ion beam generating apparatus 1 is provided with the discharging tank 2 for sealing a plasma volume. A pressure in the discharging tank 2 is maintained within a range from approximately 1×10⁻⁴ Pa (1×10⁻⁵ mbar) to approximately 1×10⁻² Pa (1×10⁻³ mbar) in general. The discharging tank 2 is sectioned by a plasma sealing container 3, and a multipole magnetic means 4 for trapping the ion discharged in the discharging tank 2 as a result of formation of the plasma is arranged around the same. The magnetic means 4 is provided with a plurality of bar-shaped permanent magnets in general. A configuration in which a plurality of relatively long bar magnets of which polarity is alternately changed are used and N and S cycles are generated only along one axis is also possible. Also, a checker board configuration in which shorter magnets are arranged such that the N and S cycles are spread on a plane formed of two orthogonal axes is also possible.

The RF power is given to a back wall of the plasma sealing container 3 by RF coil means (RF electrode) 5 to be supplied to the discharging tank 2 through a dielectric RF power coupling window 6.

As illustrated in FIG. 3, the extraction electrode 7 for extracting the ion from the plasma formed in the discharging tank 2 and accelerating the ion emitted from the plasma sealing container 3 as the ion beam is arranged on a front wall of the plasma sealing container 3. As illustrated in FIG. 4, the extraction electrode 7 includes a first inclined portion 74, a second inclined portion 75, a third inclined portion 76, a fourth inclined portion 77 having a flat grid structure with which the ion beam is obliquely incident on an irradiated surface of the substrate W and a flat portion 78 arranged so as to be substantially parallelly opposed to the irradiated surface of the substrate W. The grid structure is intended to mean the structure in which the number of minute holes for emitting the ion beam are formed.

The flat portion 78 of the extraction electrode 7 is connected to one end of a shaft (rotation supporting member) 31 and the other end of the shaft 31 is connected to a rotating mechanism (rotating driving unit) 30 located out of the discharging tank 2. The shaft 31 couples the extraction electrode 7, the rotating mechanism 30, and a voltage applying mechanism 80 to the extraction electrode 7 through a rotating sealing unit 33 capable of rotating while separating an atmosphere side and a vacuum side (in the discharging tank 2). In this embodiment, the extraction electrode 7 is rotatable by the drive of the rotating mechanism (for example, driving motor and the like) 30 through a rotary power transmitting unit (for example, rotary gear) 32. Power sources 81, 82, and 83 to supply the voltage to the extraction electrode 7 are connected to the voltage applying mechanism 80 to independently apply the voltage to the extraction electrodes 71, 72, and 73, respectively. A rotational axis of the extraction electrode 7 is arranged so as to pass through the center of the substrate W.

Also, as illustrated in FIG. 3, the first inclined portion 74 and the second inclined portion 75 are configured to be symmetrical about a rotational axis O. Similarly, the third inclined portion 76 and the fourth inclined portion 77 are also configured to be symmetrical about the rotational axis O. That is to say, as illustrated in FIG. 4, the first inclined portion 74, the second inclined portion 75, the third inclined portion 76, and the fourth inclined portion 77 are formed so as to incline to face the irradiated surface of the substrate W and are configured to be symmetrical about the rotational axis O. An incident angle θ of the ion beam with respect to the substrate W (an angle between a line perpendicular to the substrate W and the ion beam is set to θ) is preferably smaller than 90 degrees and is more preferably not smaller than 60 degrees and not larger than 85 degrees.

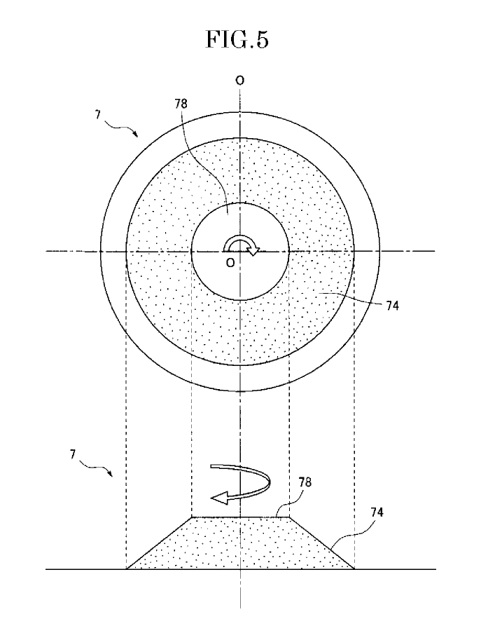

Meanwhile, although the flat portion 78 is a non-emitting portion, which does not emit the ion beam in this embodiment, this is not limited thereto and may include the grid structure so as to be able to emit the ion beam. Also, although the four inclined portions 74, 75, 76, and 78 are arranged around a square flat portion 78 in the extraction electrode 7 in this embodiment, this is not limited thereto and a plurality of inclined portions may be arranged around a polygonal flat portion. Also, it is possible to form a conical inclined portion 74 around a circular flat portion 75 as illustrated in FIG. 5.

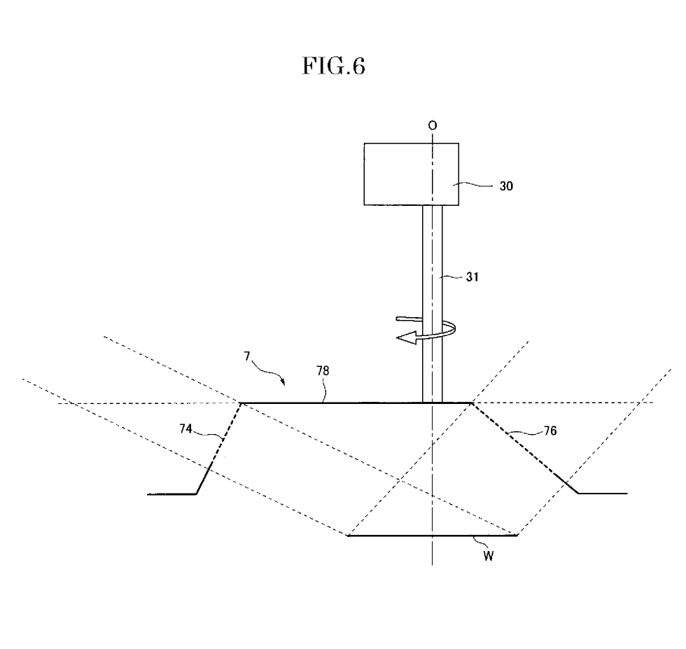

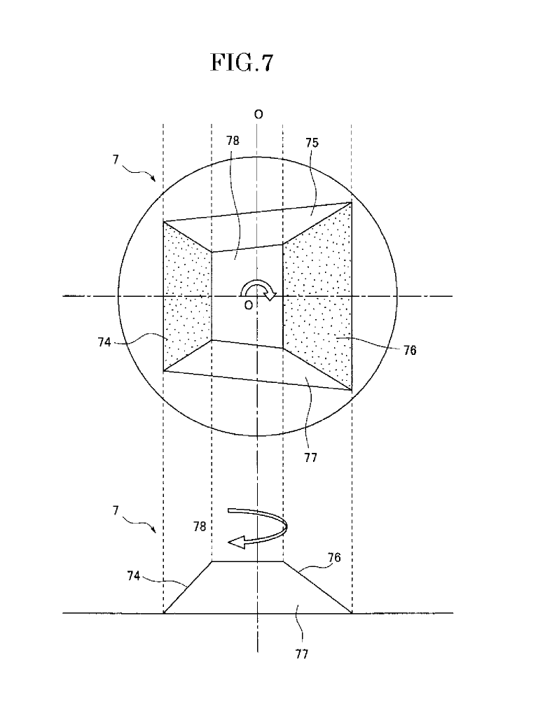

Next, a shape of the extraction electrode configured to be asymmetrical about the rotational axis of the extraction electrode is described with reference to FIGS. 6 and 7.

FIG. 6 is a cross-sectional view illustrating the shape of the extraction electrode. FIG. 7 is a top view and a side view illustrating the shape of the extraction electrode. As illustrated in FIG. 6, the first inclined portion 74 and the third inclined portion 76 are formed so as to be asymmetrical about the rotational axis. In this case, the rotational axis of the extraction electrode 7 is arranged so as to pass through the center of the substrate W. Also, as illustrated in FIG. 7, the second inclined portion 75 and the fourth inclined portion 77 are non-emitting surfaces, which do not emit the ion beam. From above, it is possible to allow the ion beam to be incident on the substrate at different angles of the first and third inclined portions 74 and 76. Further, by rotating the extraction electrode 7 by the rotating mechanism 30, it is possible to realize a highly-accurate uniform process while allowing the ion beam to be incident at different angles.

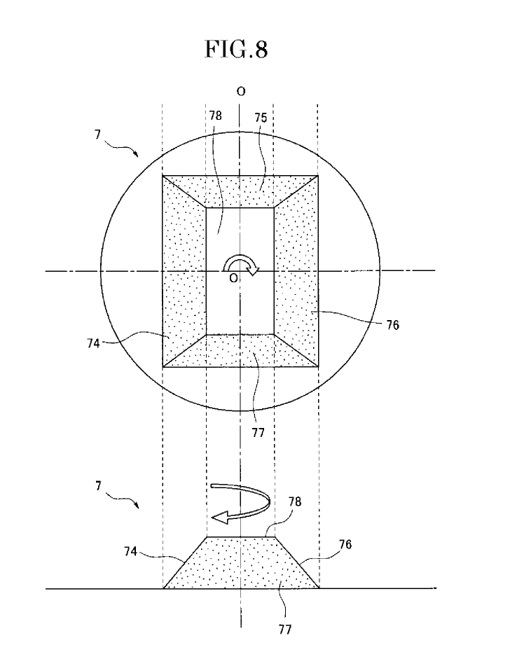

Also, another example of the extraction electrode configured to be asymmetrical about the rotational axis may have a shape illustrated in FIG. 8. That is to say, the first and second inclined portions 74 and 75 are formed so as to be asymmetrical about the rotational axis O. Similarly, the third and fourth inclined portions 76 and 77 are formed to be asymmetrical about the rotational axis O. That is to say, although the opposing inclined portions are configured to be symmetrical about the rotational axis O, the adjacent inclined portions are configured to be asymmetrical about the rotational axis. In this case, the rotational axis O of the extraction electrode 7 is arranged so as to pass through the center of the substrate W. In this manner, even with the extraction electrodes asymmetrical about the rotational axis, a uniform substrate process may be realized by rotating them.

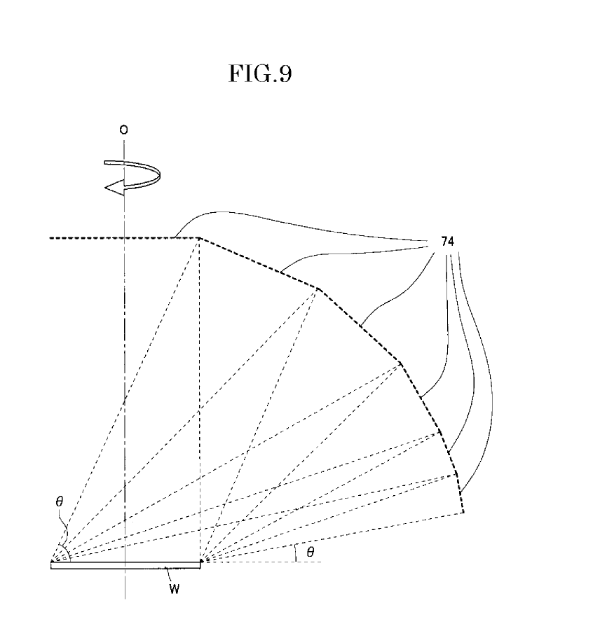

Also, as illustrated in FIG. 9, it is possible to form such that inclination angles of a plurality of inclined surfaces 74 formed so as to face the substrate W become sequentially larger from a surface to an adjacent surface toward the rotational axis.

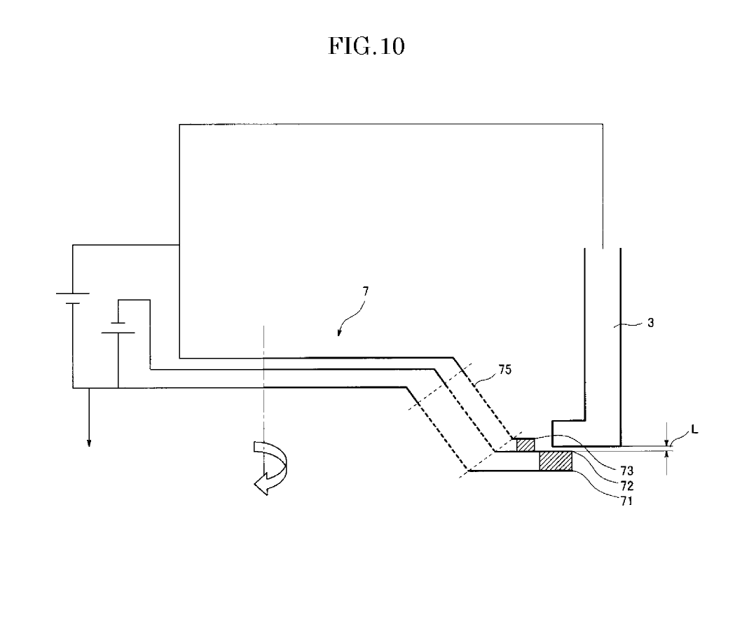

FIG. 10 is a view illustrating positional relationship between an outer periphery of an opening of the plasma sealing container 3 and the extraction electrode 7. In this embodiment, the container 3 and the first extraction electrode 71 have identical positive potential, the second extraction electrode 72 has negative potential, and the third extraction electrode 73 has ground potential. The second extraction electrode 72 is arranged in a gap between the first extraction electrode 71 and the sealing container 3 so as to be opposed to the plasma. The second extraction electrode 72 has the negative potential and the electron emitted from the plasma toward the second electrode 72 are repelled toward the plasma by the potential. Leakage of the plasma occurs by leakage of the electron and ionization of a gas molecule by the leaked electron caused following the same. Since it is configured such that the electrons are repelled by the second extraction electrode 72 in this embodiment, the leakage of discharge from the gap between the plasma extraction electrode 72 and the container 3 may be inhibited. Meanwhile, it is preferable that a distance L between a side wall of the container 3 and the second extraction electrode 72 is as small as possible (for example, 5 mm or smaller) and this is configured to be shorter than a wall sheath of source plasma. In this manner, when rotating the extraction electrode 7, an outer periphery of the extraction electrode 7 does not slide on the outer periphery of the opening of the container 3, and the leakage of the plasma from a plasma sealing unit to a side of a processed surface may be prevented.

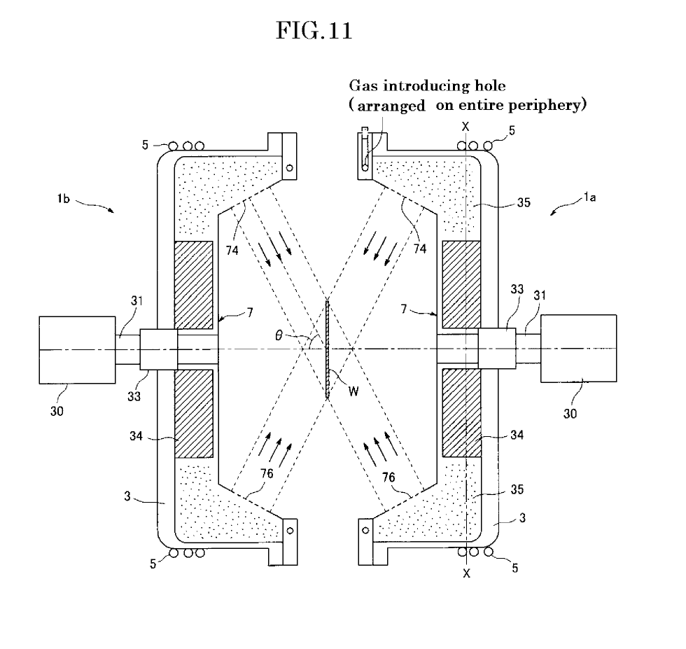

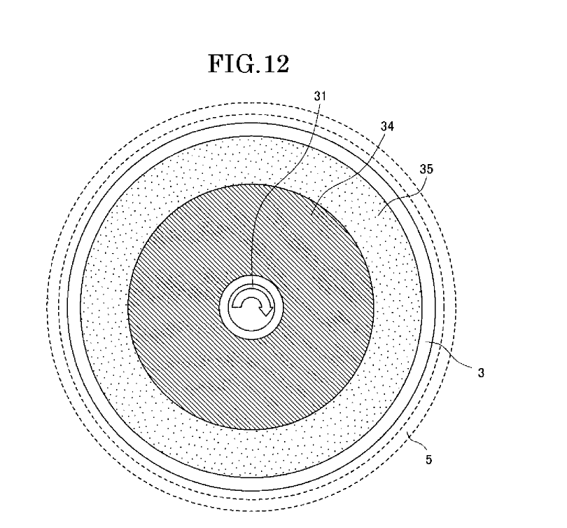

A variation to reduce power consumption of the ion beam generating apparatus will be described with reference to FIGS. 11 and 12.

FIG. 11 is a cross-sectional view illustrating a detailed configuration of the ion beam generating apparatuses 1a and 1b of one embodiment of the substrate processing apparatus of the present invention. FIG. 12 is a cross-sectional view taken along line X-X in FIG. 11. In FIG. 11, the same reference numeral is assigned to the same portion as in FIG. 3 and the description thereof will not be repeated here. Although the extraction electrode 7 is composed of the three electrodes 71, 72, and 73 as illustrated in FIG. 3, this is illustrated by one electrode for simple illustration in FIG. 11. Also, the branch reference letters a and b of the reference numeral of each member are omitted.

As illustrated in FIG. 11, a circular insulator block 34 is arranged around the shaft 31. Also, as illustrated in FIG. 12, the insulator block 34 is coaxially formed around the shaft 31. Further, an inner wall of the plasma sealing container 3 also is coaxially formed around the shaft 31. Therefore, a discharge area also is formed so as to be point-symmetrical about the shaft 31, so that a uniform plasma space is formed.

In this embodiment, a grid portion, which emits the ion, is arranged only on a part of the extraction electrode 7 and is not arranged on other parts. Especially, when the ion beam is allowed to be incident on a processed substrate W at a large angle, the grid is arranged only on the outer periphery as illustrated in FIG. 11. On the other hand, in order to minimize an ion source, configuration with a single plasma generating source is desired. In such a case, the plasma generated in a portion other than the vicinity of the grid portion does not contribute to the substrate process. It is not desirable that the plasma is thus generated in an unnecessary portion from a view point of upsizing of the power source to supply the power to the RF coil means 5 and power saving. On the other hand, by arranging the insulator block 34 on a portion other than the vicinity of the grid portion as illustrated in FIGS. 11 and 12, it is possible to form the discharge area 35 only on a necessary portion to inhibit unnecessary power consumption, and further, a higher processing speed may be realized with the same power.

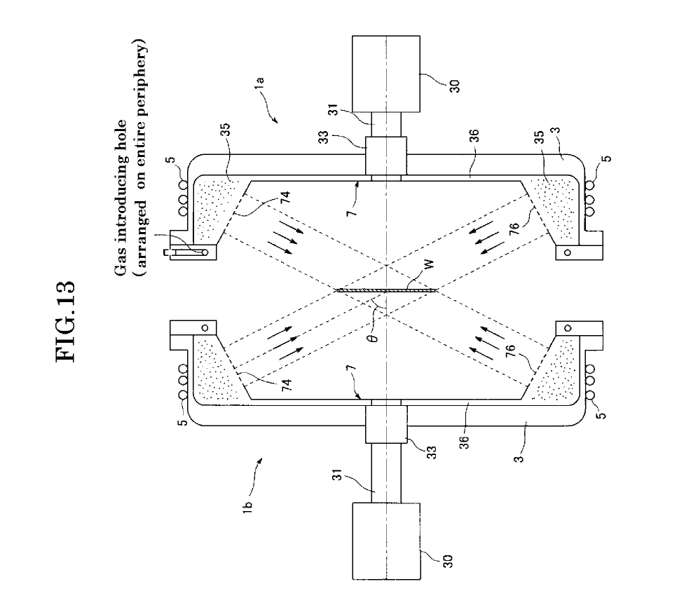

FIG. 13 illustrates another embodiment to reduce the power consumption of the ion beam. In this embodiment, a gap 36 between the plasma sealing container 3 and the extraction electrode 7 around the shaft 31 is formed so as to be sufficiently narrow such that abnormal discharge and entrance of the plasma from another space may be prevented. It is preferable that the gap is not larger than a thickness of the wall sheath of the generated plasma. On the other hand, a sufficient space 35 is ensured on the outer periphery of the container 3 in the vicinity of the grids 74 and 76 for occurrence of the discharge and diffusion of the plasma. In this manner, RF power applied to the RF coil means 5 is supplied in a concentrated manner to the space on an outer periphery of the discharging tank and is not consumed in another portion. Accordingly, the power consumption may be reduced as in the example in FIGS. 11 and 12.

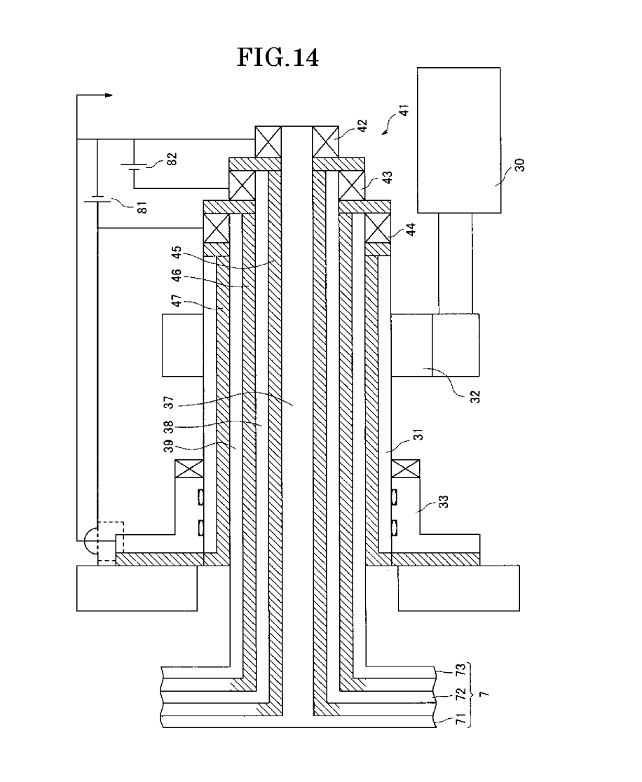

FIG. 14 is a sectional side view illustrating a detailed configuration of the rotating mechanism 30 and the voltage applying mechanism 80 of the ion beam generating apparatus of the present invention. Meanwhile, as in FIG. 3, the branch reference letter of the reference numeral of each member is omitted also in FIG. 14.

The rotating mechanism 30 is composed of a driving motor (not illustrate) and the rotary gear 32 for transmitting rotational force of the driving motor to the shaft 31. Three power introducing units 37, 38, and 39, which rotate together with the shaft 31 for supplying external power to the three extraction electrodes 71, 72, and 73, respectively, are provided in the shaft 31. Ends of the three power introducing units 37, 38, and 39 are connected to external power sources 82 and 81 through fixedly provided sliding portions 42, 43, and 44, respectively. That is to say, a rotary power introducing mechanism formed of the power introducing units 37, 38, and 39 and the sliding portions 42, 43, and 44 is provided in the shaft 31. By a slide of the power introducing units 37, 38, and 39, which rotate in this manner, and the sliding portions 42, 43, and 44, respectively, it is possible to supply the external power to the extraction electrodes 71, 72, and 73. Meanwhile, the extraction electrode 71 has the ground potential in this embodiment. Also, insulators 45, 46, and 47 are provided between each of the shaft 31 and the three rotary power introducing units 37, 38, and 39 such that they do not contact one another.

The rotating sealing mechanism 33 for maintaining a vacuum of the plasma sealing container 3 is provided between the rotating shaft 31 and the fixed plasma sealing container 3 in the vicinity of the end on a side of the extraction electrode 7 of the shaft 31. FIG. 14 illustrates the rotating sealing mechanism for maintaining the vacuum through two O-rings.

Meanwhile, although a direct-current voltage is applied to the extraction electrode 7 in this embodiment, it is also possible to apply a direct-current pulse and a radio-frequency voltage.

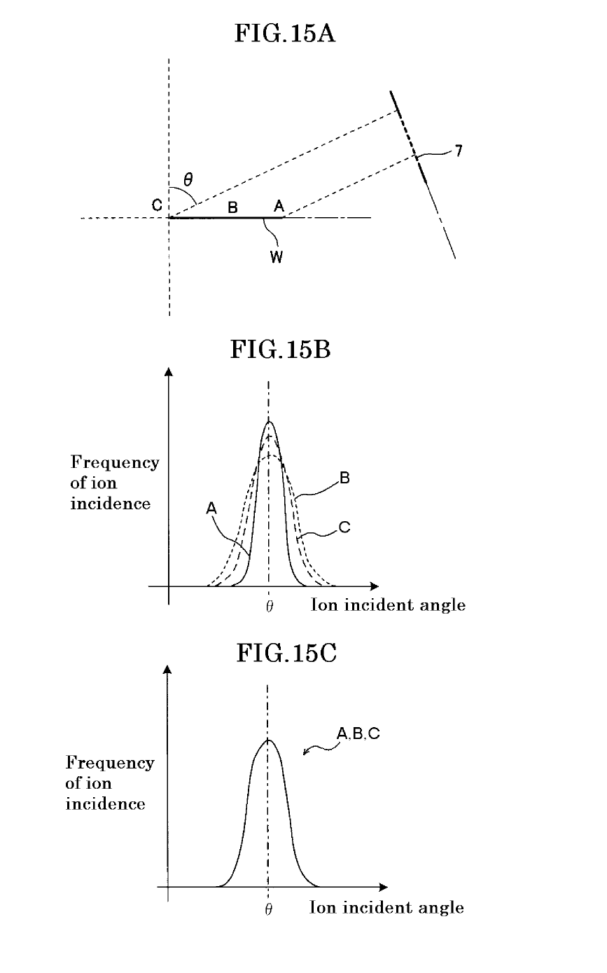

Next, a reason for rotating the extraction electrode 7 arranged so as to be inclined with respect to the substrate W will be described with reference to FIG. 15. As illustrated in FIG. 15A, an angle of the ion beam with respect to a line perpendicular to a surface of the substrate W is set to an incident angle θ and points on the substrate W are set to A, B, and C. The point A is on a left end of a plane of paper of the surface of the substrate W, the point B is on the center of the surface of the substrate W, and the point C is on a right end of the plane of paper of the surface of the substrate W. A frequency of ion incidence on each point when allowing the ion beam to be incident without rotating the extraction electrode 7 is illustrated in FIG. 15B and the frequency of ion incidence on each point when rotating the extraction electrode is illustrated in FIG. 15C. As illustrated in FIG. 15B, it is found that the frequency of ion beam incidence is different on each point on the substrate W. That is to say, when the ion beam is obliquely incident, variation occurs in the process on each point on the surface of the substrate W, so that the uniform process cannot be performed. Therefore, by rotating the extraction electrode 7, the uniform substrate process may be performed as illustrated in FIG. 15C.

Next, an action of the substrate processing apparatus 100 of this embodiment will be described with reference to FIG. 1.

The first ion beam generating apparatus 1a emits the ion beam to one surface (processed surface) of the substrate W and one processed surface of the substrate W is processed. Similarly, the second ion beam generating apparatus 1b emits the ion beam to the other processed surface of the substrate W and the other processed surface of the substrate W is processed.

In the substrate processing apparatus 100 of this embodiment, the extraction electrodes 7a and 7b are formed so as to be inclined on the first and second ion beam generating apparatuses 1a and 1b, respectively, such that the ion is obliquely incident on each processed surface of the substrate W and it is configured such that the extraction electrodes 7a and 7b are rotated by rotating mechanisms 30a and 30b, which rotate. The substrate W is arranged in a static state (substrate arranging step) and by allowing the ion beam to be obliquely incident on the substrate W (emitting step) while rotating the extraction electrodes 7a and 7b (rotating step), time average of dispersion of the incident angle on each position in the substrate when the ion beam is incident on the substrate W may be made constant and the uniform substrate process may be realized.

Next, an effect of inclining the incident angle of the ion beam according to the present invention is described.

As an example to perform a surface process to the substrate by allowing the ion beam to be incident thereon, there is the etching process, for example, including processing and entire processing of a film deposited on the substrate into a predetermined shape, planarization of a concavo-convex surface formed on the substrate and the like.

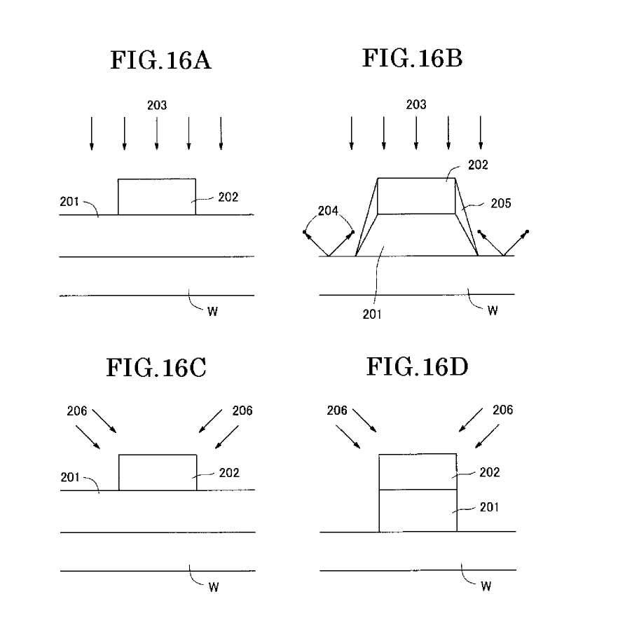

FIG. 16 is a cross-sectional view schematically illustrating a step of performing microfabrication of the film deposited on the substrate into a predetermined shape by allowing the ion beam to be incident thereon. First, as illustrated in FIGS. 16A and 16C, a photoresist 202 is formed on a processed film 201 deposited on the processed substrate W by a sputtering method, a CVD method and the like by lithography into a predetermined shape, and by using the same as a mask, the ion beam generating apparatus emits ion beams 203 and 206 to process the processed film 201. In an application in which the microfabrication is required such as in the processing of a semiconductor substrate, the processing just as a designed pattern, that is to say, perpendicular processing, which further conforms to the mask, is desired in order to ensure performance of a device.

At that time, the ion beam generating apparatus accelerates the ion generated by introducing predetermined gas into the plasma source by the extraction electrode, and performs the etching process by emitting the ion beam to the substrate. At that time, when inactive gas such as Ar and He is used and when a processed material is a so-called dry etching resist material and a volatile product is not formed by chemical reaction of the processed material and active species generated by the plasma, adhesive particles 204 scatter from the processed surface of the substrate by sputtering. The particles scatter in a direction with a certain distribution such as the distribution proportional to the cosine of a discharge angle according to a general sputtering theory, for example, so that a part of them scatters in a direction of a side surface of a processed body and thereafter adheres, thereby inhibiting perpendicular progress of the etching to form a pattern side surface deposited film 205. A side wall of the pattern presents a tapered shape by the deposited film 205 as illustrated in FIG. 16B. When the etching is actually performed by such perpendicular incidence, a taper angle of approximately 75 degrees or larger cannot be obtained. When the ion beam is allowed to incident on the tapered side wall in a direction perpendicular to the substrate (ion incident angle is 0 degree), the ion incident angle of the side wall surface becomes significantly large. For example, when the taper angle of the side wall is 75 degrees, according to FIG. 2 of the document “R. E. Lee: J. Vac. Sci. Technol., 16, 164 (1979)”, the ion incident angle with respect to the side wall becomes 75 degrees. Therefore, an etching speed of the side wall extremely decreases as compared to that of an etched surface parallel to the substrate of which ion incident angle is 0 degree. Meanwhile, the taper angle is intended to mean an angle between the side wall and the substrate surface, and the ion incident angle is intended to mean an angle of inclination of the incident ion beam with respect to a direction perpendicular to an incident surface, which is 0 degree when the ion beam is perpendicularly incident on the etched surface, for example.

On the other hand, when the inclined ion beam 206 is emitted at a 15-degree angle, for example (FIG. 16C), the side surface with the taper angle of 75 degrees, for example, is irradiated with the ion beam at the ion incident angle of 60 degrees. Also, the etched surface (substrate surface) is irradiated with the ion beam at the ion incident angle of 15 degrees. Therefore, according to the above-described document, difference in etching speed significantly decreases as compared to a case where the ion beam is not inclined. Therefore, the etching progresses also on the side wall of the processed film 201 and the etched side surface further perpendicular may be obtained as illustrated in FIG. 16D.

Since the ion beam generating apparatus of the present invention allows the ion beam to be uniformly incident on the substrate W by inclining the ion beam and rotating the extraction electrode, the surface process of the substrate may be uniformly and efficiently performed.

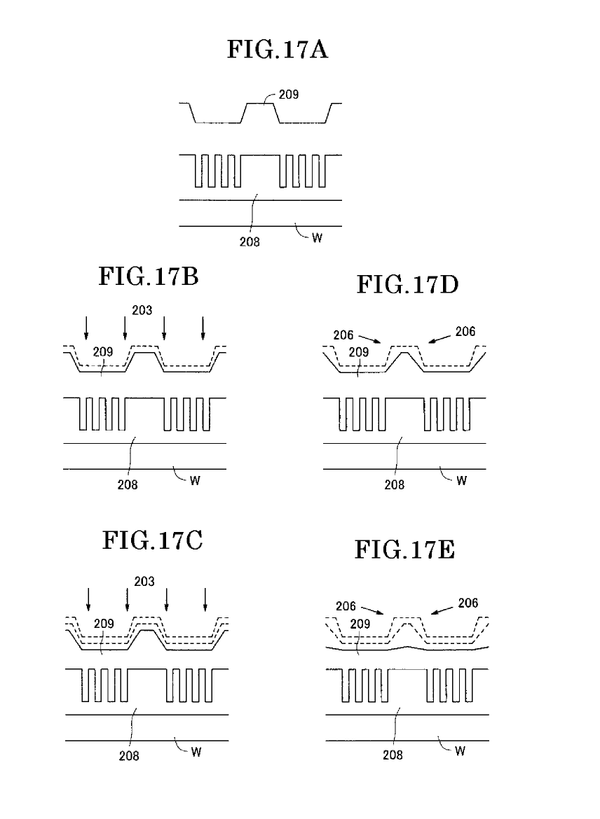

FIG. 17 illustrates an example of the planarization of the concavo-convex surface on the substrate surface using the ion beam generating apparatus of oblique incidence and the ion beam generating apparatus of perpendicular incidence.

As illustrated in FIG. 17A, after depositing a processed layer 208 on the processed substrate W in advance, a microfabrication process is performed by the etching and the like using a lithography method. The etching is performed by an obliquely incident ion beam as in FIGS. 16C and 16D, for example. Embedded deposition is performed by using the sputtering method and the like, for example, on the etched layer 208 to form an embedded layer 209. When the deposition is performed by the sputtering and the like, a step is generated on a surface of the embedded layer 209 between a portion in which the pattern is present and a portion in which the pattern is not present as illustrated in FIG. 17A. This is because sputtering particles are uniformly incident on the substrate surface, so that a volume of the formed film is equal in each part of the substrate. In a part of semiconductor processing and magnetic disc processing, it is desired to planarize such concavo-convex surface in order to ensure the performance of the apparatus and for convenience of a next step.

FIGS. 17B and 17C illustrate change in the surface shape when the ion beam 203 is allowed to be perpendicularly incident on the concavo-convex surface. In this case, although the surface parallel to the substrate W is uniformly processed, since the incident angle of the ion beam is significantly large in the tapered portion, the portion has a shape in which the progress of the etching is inhibited. Since the ion beam has an effect to selectively etch a corner of the convex portion, the convex portion is made round, but a sufficient effect of the planarization cannot be obtained.

On the other hand, when the ion beam 206 is allowed to be incident on a side wall surface of the step substantially perpendicularly, that is to say, at an angle with respect to the substrate surface as illustrated in FIGS. 17D and 17E, it is possible to etch the side wall of the step at a significantly high etching speed as compared to that of the surface parallel to the substrate. By this, only a width of the convex portion becomes gradually smaller and the convex portion finally disappears, so that the flat surface may be obtained. For example, when the side wall of the step has the taper of 75 degrees, when the ion beam 206 is allowed to be incident at a 60-degree angle, the side wall surface of the step is irradiated with the ion beam at the ion incident angle of 15 degrees. At that time, the incident angle of the ion beam with respect to the surface parallel to the substrate W is 60 degrees, and according to the above-described document, the surface of the step is etched at the significantly high etching speed.

Since the ion beam generating apparatus of the present invention uniformizes the ion beam to be incident on the substrate W by inclining the ion beam irradiated surface and inclining the extraction electrode by rotating the same, the surface process of the substrate may be uniformly and efficiently performed.

Conventionally, in the apparatus in which the ion beams are arranged so as to be opposed to each other for simultaneously processing the both surfaces of the substrate, there is a case of providing a substrate rotating mechanism in order to uniformize a time average value of the dispersion of the ion incident angle. However, a portion in which the incidence of the ion beam is inhibited is generated by the mechanism, or it is required to provide the sliding portion on the outer periphery of the substrate as in FIG. 5 of the Japanese Patent Application Laid-Open No. 2008-117753. When the sliding portion is provided on the outer periphery of the substrate, unnecessary particles are adhered to the substrate and this leads to significant inhibition of a yield. In addition, an extremely large structure is required for rotating the substrate without inhibiting the ion beam and without providing the sliding portion on the substrate portion. In the ion beam generating apparatus of the present invention, bias of the ion beam on the substrate surface is prevented by the rotation of the extraction electrode, so that it is not required to uniformize the time average value of the dispersion of ion incident angle by providing the rotating mechanism of the substrate and the like as described above.

As described above, in the substrate processing apparatus 100 of this embodiment, it is possible to configure a small apparatus of generating uniform inclined ion beam in which generation of the particles is inhibited for performing the etching with higher pattern accuracy and for planarizing the concavo-convex surface by inclining the ion beam irradiated surface and rotating the extraction electrode in the opposed ion beam generating apparatuses 1a and 1b.

The ion beam generating apparatus of the present invention is preferably applied to a step of manufacturing an electronic device when etching the substrate surface to perform the microfabrication and the planarization as described above.

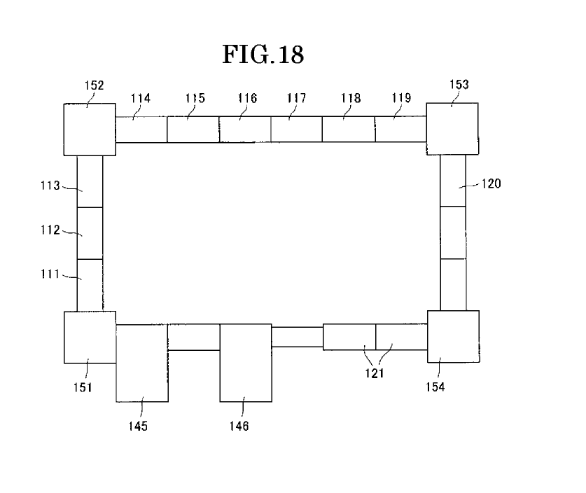

FIG. 18 is a schematic configuration diagram of a discrete track media processing/depositing apparatus, which is a manufacturing apparatus when using the substrate processing apparatus provided with the ion beam generating apparatus of the present invention to manufacture the magnetic recording medium. The manufacturing apparatus of this embodiment is an in-line manufacturing apparatus in which a plurality of chambers 111 to 121 capable of evacuating are connected to be arranged in an endless rectangular shape as illustrated in FIG. 18. Then, in each of the chambers 111 to 121, a carrying path for carrying the substrate to an adjacent vacuum chamber is formed and the substrate is sequentially processed in each vacuum chamber while moving around the manufacturing apparatus. Also, a carrying direction of the substrate is switched in direction switching chambers 151 to 154, the carrying direction of the substrate, which is linearly carried through the chambers, is rotated by 90 degrees and the substrate is passed to a next chamber. The substrate is introduced into the manufacturing apparatus by a load lock chamber 145 and is carried out of the manufacturing apparatus by an unload lock chamber 146 when the process is finished. Meanwhile, it is also possible to sequentially arrange a plurality of chambers capable of executing the same process such as the chambers 121 and allow the same to perform the same process in several batches. By this, the process, which takes time, may also be performed without extension of a tact time. Although only the chambers 121 are plural in the apparatus in FIG. 18, multiple arrangement of another chamber is also possible.

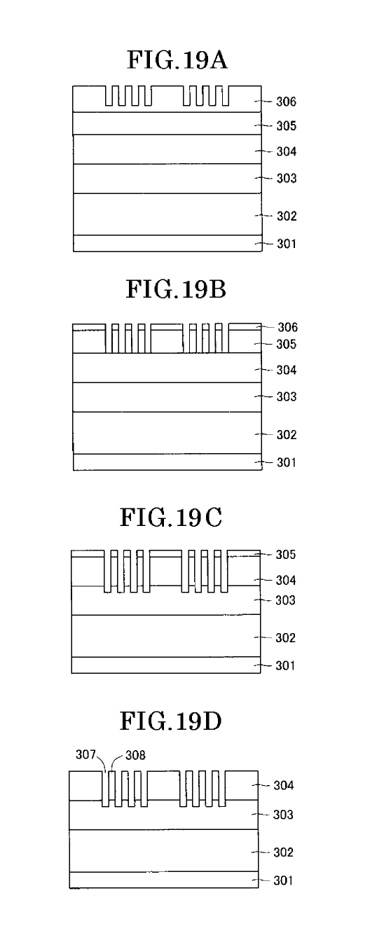

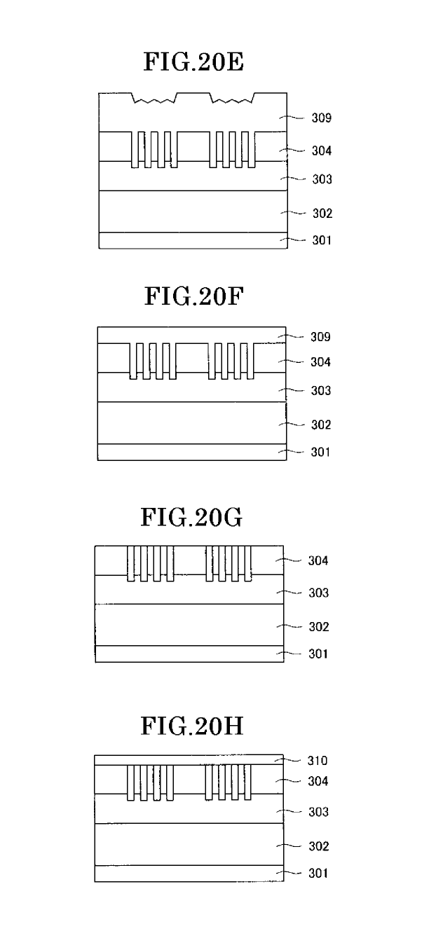

FIGS. 19 and 20 are cross-sectional views schematically illustrating a step of processing a laminated body by the manufacturing apparatus of this embodiment. FIG. 19A is a cross-sectional view of the laminated body processed by the manufacturing apparatus of this embodiment. Meanwhile, although the laminated bodies are formed on both surfaces of the substrate 301 in this embodiment, as a matter of convenience, in FIGS. 19 and 20, it is focused on the process of the laminated body formed on one surface of the substrate 301 in order to simplify the drawings and the description and the laminated body formed on the other surface and the process thereto are omitted.

The laminated body is in the middle of processing into the discrete track media (DTM) and is provided with the substrate 301, a soft magnetic layer 302, a base layer 303, a recording magnetic layer 304, a mask 305, and a resist layer 306 as illustrated in FIG. 19A. Such laminated body is introduced into the manufacturing apparatus illustrated in FIG. 18. As the substrate 301, a glass substrate and an aluminum substrate of which diameter is 2.5 inches (65 mm) may be used, for example. Meanwhile, although the soft magnetic layers 302, the base layers 303, the recording magnetic layers 304, the masks 305, and the resist layers 306 are formed on both opposite surfaces of the substrate 301, the laminated body formed on one surface of the substrate 301 is omitted in order to simplify the drawing and the description as described above.

The soft magnetic layer 302 is the layer, which serves as a yoke of the recording magnetic layer 204, and includes a soft magnetic material such as Fe alloy and Co alloy. The base layer 303 is the layer to direct an easy axis of the recording magnetic layer 304 in a perpendicular direction (lamination direction of laminated body 300) and includes the laminated body of Ru and Ta and the like. The recording magnetic layer 304 is the layer magnetized in the direction perpendicular to the substrate 301 and includes the Co alloy and the like.

Also, the mask 305 is used for forming a groove on the recording magnetic layer 304 and diamond-like carbon (DLC) and the like may be used. The resist layer 306 is the layer for transferring a groove pattern to the recording magnetic layer 304. In this embodiment, the groove pattern is transferred to the resist layer by a nanoimprint method and this is introduced in this state into the manufacturing apparatus illustrated in FIG. 18. Meanwhile, the groove pattern may be transferred not only by the nanoimprint method but also by exposure and development.

In the manufacturing apparatus illustrated in FIG. 18, a groove of the resist layer 306 is removed by reactive ion etching in the first chamber 111, then the mask 305 exposed in the groove is removed by the reactive ion etching in the second chamber 112. Across section of the laminated body 300 at that time is illustrated in FIG. 19B. Thereafter, the recording magnetic layer 304 exposed in the groove is removed by ion beam etching in the third chamber 113 to form the recording magnetic layer 304 as a concavo-convex pattern in which tracks are separated from each other in a radial direction as illustrated in FIG. 19C. For example, a pitch (groove width+track width) at that time is between 70 and 100 nm, the groove width is between 20 and 50 nm, and a thickness of the recording magnetic layer 204 is between 4 and 20 nm. In the third chamber 113, by performing ion beam processing using the ion beam generating apparatus of the present invention, it is possible to perform the etching with the high pattern accuracy and excellence in uniformity in the substrate.

In this manner, a step of forming the recording magnetic layer 304 of the concavo-convex pattern is performed. Thereafter, in the fourth and fifth chambers 114 and 115, the mask 305 remained on a surface of the recording magnetic layer 304 is removed by the reactive ion etching. By this, a state in which the recording magnetic layer 304 is exposed is obtained as illustrated in FIG. 19D.

Next, a step of depositing the embedded layer formed of a nonmagnetic material in a concave portion of the recording magnetic layer 304 to fill the same and an etching step of removing a surplus embedded layer by the etching are described with reference to FIGS. 20E to 20H.

As illustrated in FIG. 19D, after exposing the recording magnetic layer 304 of the laminated body, in an embedded layer forming chamber 117, an embedded layer 309 is deposited on a surface of a groove 307 being the concave portion of the recording magnetic layer 304 as illustrated in FIG. 20E. Meanwhile, the embedded layer forming chamber 117 serves as a second depositing chamber for depositing the embedded layer 309 of the nonmagnetic material on a nonmagnetic conductive layer to fill. The embedded layer 309 is the nonmagnetic material, which does not affect to recording and reading to and from the recording magnetic layer 304, and Cr, Ti, and alloy thereof (such as CrTi) may be used, for example. As the nonmagnetic material, a material, which loses characteristics as a ferromagnetic material as a whole by including another diamagnetic material and nonmagnetic material, may be used even through this includes the ferromagnetic material.

Although the method of depositing the embedded layer 309 is not especially limited, a bias voltage is applied to the laminated body and RF-sputtering is performed in this embodiment. By applying the bias voltage in this manner, the sputtered particles are brought into the groove 307 and generation of a void is prevented. As the bias voltage, the direct-current voltage, an alternating-current voltage, and the direct-current pulse voltage may be applied, for example. Although a pressure condition is not especially limited, an embedding property is excellent under a condition of relatively high pressure between 3 and 10 Pa, for example. Also, by performing the RF-sputtering with a high rate of ionization, a convex portion 308 on which the embedded material is easily laminated as compared to the groove 307 may be simultaneously etched with the deposition by ionized gas for discharge. Therefore, difference in thickness of lamination between the groove 307 and the convex portion 308 may be inhibited. Meanwhile, it is possible to laminate the embedded material in the groove 307 being the concave portion using collimated sputtering and low-pressure remote sputtering.

Meanwhile, although not illustrated, an etching stop layer may be deposited before the embedded layer 309 is deposited. As the etching stop layer, a material of which etching speed is lower than that of the embedded layer 309 above the same in a condition of planarization to be described later is preferably selected. By this, a function to inhibit the recording magnetic layer 304 from being damaged by excessive etching at the time of the planarization may be given. Also, when a nonmagnetic metal material is selected as the etching stop layer, the bias voltage at the time of the deposition of the embedded layer 309 in a later step may effectively serve and the generation of the void may be effectively inhibited.

An etching stop layer depositing chamber 116 is included in FIG. 18.

Although minute concavity and convexity are basically embedded on the surface after the embedded deposition as illustrated in FIG. 20E, this is lower than the flat surface as described above. When the thickness of the embedded layer is not sufficient on the minute concavity and convexity, the minute concavity and convexity might be remained.

Next, in the first etching chamber 118, as illustrated in FIG. 20F, the embedded layer 309 is removed except the embedded layer 309 slightly remained on the recording magnetic layer 304. In this embodiment, the embedded layer 309 is removed by the ion beam etching using the inactive gas such as the Ar gas as the ion source.

At that time, by emitting the inclined ion beam using the ion beam generating apparatus of the present invention, the step formed on the surface is effectively planarized. The inclination angle of the ion beam may be a single angle or combination of a plurality of angles, or may be obtained by combining the perpendicular incidence, and a grid shape is selected according to the step on the surface for optimization. Also, by rotating the extraction electrode, the dispersion of the incident angle of the ion beam may be uniformized in the substrate, so that extremely highly-accurate planarization may be realized.

The first etching chamber 118 is provided with ion beam generating apparatuses 1a and 1b of the present invention illustrated in FIG. 1. The first etching chamber 118 is the chamber for removing a part of the embedded layer 309 by the ion beam etching. Meanwhile, a specific etching condition is such that a chamber pressure is not larger than 1.0×10⁻¹ Pa, voltages V1 and VB1 of the extraction electrodes 71a and 71b are not smaller than +500 V, voltages V2 and VB3 of the extraction electrodes 72a and 72b are between −500 V and −2000 V, and the RF power in inductively-coupled plasma (ICP) discharge is approximately 200 W, for example.

By continuing the ion beam etching also after the planarization, the remained embedded layer 309 is fully removed as illustrated in FIG. 20G.

A second etching chamber 119 for removing the etching stop layer not illustrated is also illustrated in FIG. 18. Meanwhile, the etching chamber 119 is composed of a mechanism to apply the bias such as DC, RF, and DC pulse to the carrier using ICP plasma by the reactive gas and the like.

Next, as illustrated in FIG. 20H, a DLC layer 310 is deposited on the planarized surface. In this embodiment, the deposition is performed in a protective film forming chamber 121 after it is adjusted to a temperature required for forming the DLC in a heating chamber 120 or a cooling chamber. A deposition condition may be such that, in a parallel-plate CVD, for example, the radio-frequency power is 2000 W, a pulse-DC bias is −250 V, a substrate temperature is between 150 and 200 degrees, and a chamber pressure is approximately 3.0 Pa, and the gas may be C₂H₄ with a flow rate of 250 sccm. An ICP-CVD and the like may also be used.

Although the embodiment of the present invention has been described above, the present invention is not limited to the above-described embodiment.

For example, when the mask 305 is of carbon, the mask 305 may be remained instead of forming the etching stop layer. However, in this case, the thickness of the mask 305 might vary by twice etching: the etching for removing the resist layer 306 and the etching for removing the surplus embedded layer 309. Therefore, it is preferable to remove the mask 305 to form the etching stop layer as in the above-described embodiment. In this case, the etching stop layer may be formed on a bottom surface and a wall surface of the groove 307, and when a conductive material is used as the etching stop layer, the bias voltage is easily applied as described above, so that this is preferable.

Although a case of the DTM has been described, the present invention is not limited thereto. For example, the present invention may be applied to a case where the embedded layer 208 is formed on the concavo-convex pattern of a BPM in which the recording magnetic layer 304 is scattered.

The present invention may be applied not only to the illustrated substrate processing apparatus (magnetron sputtering apparatus), but also to a plasma processing apparatus such as a dry etching apparatus, a plasma asher apparatus, a CVD apparatus, and a liquid crystal display manufacturing apparatus.

Also, there are a semiconductor and the magnetic recording medium as the electronic device capable of using the ion beam generating apparatus of the present invention in manufacture.

### EXPLANATION OF REFERENCE NUMERALS

1, 1a, 1b: ion beam generating apparatus
2, 2a, 2b: discharging tank
7, 71, 72, 73: extraction electrode
20: substrate holder
30: rotating mechanism (rotating driving unit)
31: shaft (rotation supporting member)
34: insulator block
74, 75, 76, 77: inclined portion

1. An ion beam generating apparatus, comprising: a discharging tank for generating plasma; an extraction electrode including an inclined portion arranged so as to be inclined with respect to an irradiated surface for extracting an ion generated in the discharging tank; and a rotating driving unit for rotating the extraction electrode.

2. The ion beam generating apparatus according to claim 1, comprising a rotation supporting member for coupling the rotating driving unit and the extraction electrode, wherein an insulator block arranged around the rotation supporting member is included in the discharging tank.

3. The ion beam generating apparatus according to claim 2, wherein the rotation supporting member includes a rotary power introducing mechanism for supplying external power to the extraction electrode while rotating.

4. The ion beam generating apparatus according to claim 1, wherein the extraction electrode is configured to be symmetrical about a rotational axis of the extraction electrode.

5. The ion beam generating apparatus according to claim 1, wherein the extraction electrode is configured to be asymmetrical about a rotational axis of the extraction electrode.

6. The ion beam generating apparatus according to claim 1, wherein the extraction electrode includes a non-emitting unit provided so as to face the irradiated surface, which does not emit the ion.

7. A substrate processing apparatus, comprising a substrate holder for holding a substrate, wherein the ion beam generating apparatus according to claim 1 is provided so as to face each of both surfaces of the substrate.

8. A method of manufacturing an electronic device using an ion beam generating apparatus comprising a discharging tank for generating plasma; an extraction electrode including an inclined portion arranged so as to be inclined with respect to an irradiated surface for extracting an ion generated in the discharging tank; and a rotating driving unit for rotating the extraction electrode, the method comprising: a substrate arranging step for arranging a substrate such that a surface of the substrate is inclined with respect to the inclined portion of the extraction electrode, an emitting step for extracting the ion from the inclined portion of the extraction electrode to emit the ion to the substrate, and a rotating step for rotating the extraction electrode.
